(19) United States
(12) Patent Application Publication
(10) Pub. No.: US 2005/0242795 A1
(43) Pub. Date: Nov. 3, 2005

(54) MMIC DC-to-DC converter

(76) Inventors: Shihab Al-Kuran, Green Brook, NJ (US); Norman Sheinberg, South River, NJ (US)

Correspondence Address: PENNIE & EDMONDS LLP;Counsellors at Law, 1155 Avenue of the Americas, New York, NY, 10036-2711, US

(21) Appl. No.: 10/042,720

(22) Filed: Aug. 22, 2001

(51) Int. Cl. G05F 1/40

(52) U.S. Cl. 323/282

(57) ABSTRACT

An improved Monolithic Microwave Integrated Circuit DC-to-DC voltage converter fabricated in GaAs MESFET technology is introduced. The converter comprises a differential oscillator having crossed-coupled symmetrical inductors that ensure low-noise operation. The converter further comprises a highly-efficient synchronous rectifier and a start-up enable circuit.

### FIELD OF THE INVENTION

The present invention relates to DC-to-DC voltage conversion, and, more particularly, to a high-efficiency, low-noise DC-to-DC negative voltage converter that may be produced on a monolithic microwave integrated circuit (“MMIC”).

### BACKGROUND OF THE INVENTION

The past two decades have been characterized by the growth in popularity of hand-held communication devices operating at microwave frequencies. Typically, these devices are powered by a battery that provides only a positive DC voltage at a single voltage level. Since various circuit components require different voltage levels to function properly, DC-to-DC voltage converters are necessary for these devices.

Presently, the technology of choice for hand-held communication devices is monolithic microwave integration. The best performance is obtained using Depletion-type Metal-Semiconductor Field Effect Transistors (“D-MESFETs”) on a Gallium-Arsenide (“GaAs”) substrate. The high current density and high breakdown voltage of a D-MESFET, coupled with the high electron mobility and high peak velocity of GaAs, translates into high-frequency operation ideal for communication circuits. A D-MESFET operates most efficiently with its source grounded, a positive voltage V_{DD} applied to its drain, and a negative bias voltage—V_{G} applied to its gate, as shown in FIG. 1. Further, a D-MESFET may be disabled or powered down—e.g., to save power and extend battery life—by making the magnitude of the negative bias voltage—V_{G} relatively large.

Accordingly, DC/DC voltage converter circuits operable from a battery have been developed to provide such negative bias voltages. One such known D-MESFET/GaAs-based DC/DC converter is shown in FIG. 2. Converter 200 comprises: (1) differential oscillator 210, which produces an AC voltage; and (2) rectifier 220, which rectifies the produced AC voltage to a negative DC voltage V_{SS}.

Differential oscillator 210 comprises symmetric inductors L1 and L2, capacitors C1 and C2, and MESFET transistors M1 and M2, connected in the well-known transistor astable multivibrator configuration. That is, the gate of transistor M1 is coupled to the drain of M2 through the capacitor C1, and, conversely, the gate of transistor M2 is coupled to the drain of transistor M1 through capacitor C2. The drains of transistors M1 and M2 are coupled to the supply voltage V_{GEN} through inductors L1 and L2, respectively.

Briefly, differential oscillator 210 operates by alternately switching transistors M1 and M2 “on” and “off”; the switching action occurs as a result of the interconnections between transistors M1 and M2 through capacitors C1 and C2. Further detail on the operation of differential oscillator 210 is provided below. General background material about transistor astable multivibrators can be found in PAUL M. CHIRLIAN, ANALYSIS AND DESIGN OF INTEGRATED ELECTRONIC CIRCUITS 958-960 (2d ed. 1987).

Rectifier 210 comprises diodes D1 and D2, which are coupled to the gates of transistors M1 and M2, respectively. Diodes D1 and D2, in combination with the parasitic diodes that exist between the gate and source of each of transistors M1 and M2, act as negative peak detectors that output the desired negative DC output voltage V_{SS}. Capacitor C_{H} serves to stabilize voltage V_{SS}.

Although the above-described DC-to-DC converter is well-suited for use in certain applications, the present inventor has discovered a number of shortcomings in its design. First, symmetric inductors L1 and L2, which are traditionally manufactured on the MMIC as single-plane, spiral-wound inductors, require a relatively large amount of die space on the integrated circuit. Second, the voltage drop across diodes D1 and D2 reduces the magnitude of the negative DC output voltage V_{SS} and thereby reduces the efficiency of the DC/DC voltage conversion. Third, it is possible for a positive voltage to build up across the load while converter 200 is powered off. Because diodes D1 and D2 are forward-biased under these circumstances, the positive voltage (minus the diode voltage drop) is transferred to the gates of transistors M1 and M2, and may force transistors M1 and M2 into saturation. When converter 200 is subsequently powered on by the application of supply voltage V_{GEN}, strong drain-source currents may be established in transistors M1 and M2, and, as a result, oscillator 210 can fail to begin oscillating.

### OBJECT OF THE INVENTION

In light of the above-identified shortcomings of the prior art DC/DC voltage converter described above, one object of the invention is to provide a DC/DC converter having improved power efficiency and start-up reliability and requiring a reduced die area. Additional objects, advantages and novel features of the invention will be set forth in part in the description which follows, and in part will become apparent to those skilled in the art or may be learned by practice of the invention.

### SUMMARY OF THE INVENTION

An improved MMIC DC-to-DC converter in accordance with the invention comprises a differential oscillator, a synchronous rectifier, and, preferably, a start-up circuit. The oscillator comprises first and second transistors capable of being coupled to a voltage supply through respective first and second inductors. These inductors are preferably cross-coupled, in order to increase the effective inductance of each inductor and thereby permit the use of smaller-valued inductors that may be manufactured in a smaller die area. The cross-coupling is preferably achieved by forming the first and second inductors as symmetrical, interleaved spiral inductors that are nearly identical in inductance value, so that a highly-balanced circuit results. In such a balanced circuit, the even-frequency components of the oscillator cancel out in the output voltage V_{SS}, and the noise produced by the oscillator is thereby reduced.

In order to improve the efficiency of the converter, the rectifier is preferably a synchronous rectifier comprising two MESFET transistors that operate synchronously with the oscillator to rectify each negative swing of the voltages presented by the oscillator. The transistors have a very small voltage drop across their drain-source junctions, and the efficiency of the conversion thereby is increased in comparison with the diode-based rectifier used in the prior art converter described above.

The start-up problem referred to above is addressed by the addition of a start-up circuit at the output of the converter. In a preferred embodiment, the start-up circuit comprises a Schottky diode connected in parallel with the load. The voltage across the load is thereby prevented from increasing beyond the threshold voltage of the diode, and, in turn, the voltage at the gates of the first and second transistors of the oscillator is limited to a value that permits the successful start-up of the oscillator.

### BRIEF DESCRIPTION OF THE DRAWINGS

For a more complete understanding of the present invention reference is now made to the following descriptions taken in conjunction with the accompanying drawings, in which:

FIG. 1 illustrates a schematic circuit diagram of a D-MESFET;

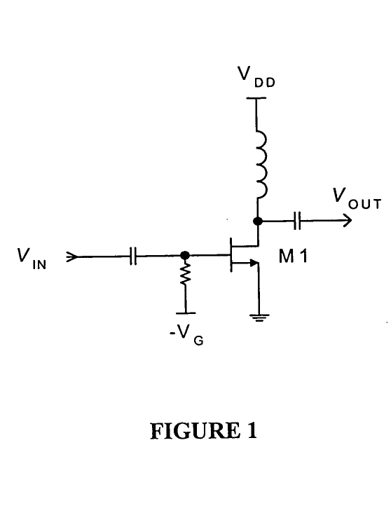

FIG. 2 shows a prior art MMIC DC-to-DC negative voltage converter;

FIG. 3 illustrates an MMIC DC-to-DC negative voltage converter embodying the present invention; and

FIG. 4 is an elevation view of the cross-coupled symmetrical inductors L1 and L2.

### DETAILED DESCRIPTION OF THE INVENTION

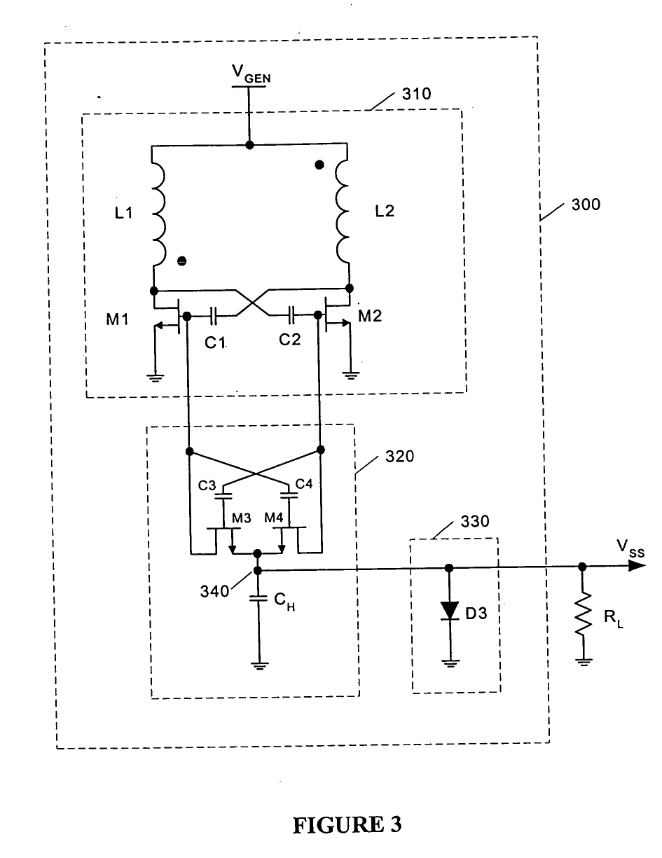

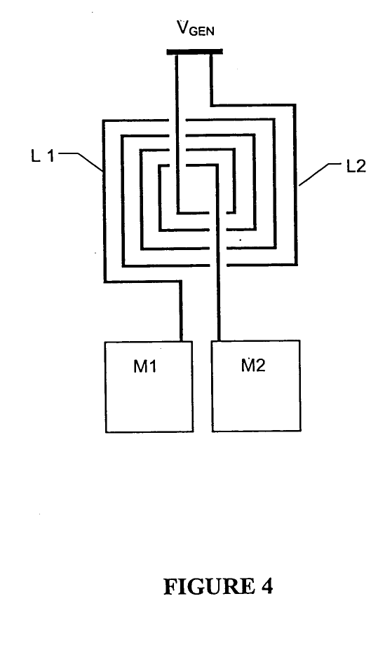

With reference to FIG. 3, a microwave DC-to-DC negative voltage converter 300 in accordance with the present invention comprises differential oscillator 310, rectifier 320, and startup circuit 330. Differential oscillator 310, like the prior art differential oscillator 210 described above, comprises inductors L1 and L2, transistors M1 and M2, and capacitors C1 and C2, which are connected in the well-known transistor astable multivibrator configuration. In the present invention, however, inductors L1 and L2 are cross-coupled, interleaved spiral conductors of the type described in U.S. Pat. No. 5,892,425 to Kuhn et al. and shown in FIG. 4. The spiral conductors are arranged in the same plane on the substrate and connected to voltage supply V_{GEN} and transistors M1 and M2 in such a way that inductors L1 and L2 are mirror images of each other. This configuration allows nearly perfect symmetry of the two inductors, which enables such a highly-balanced circuit operation that even-order harmonic noise components produced by differential oscillator 310 cancel out. In addition, because of the cross-coupling, the effective inductance of each inductor is increased, and inductors L1 and L2 can have smaller values than those used in prior art voltage converters.

Further as shown in FIG. 3, rectifier 320 is preferably a synchronous-type rectifier comprising rectifying transistors M3 and M4 and capacitors C3, C4 and C_{H}. Synchronous rectifiers generally are described, e.g., in U.S. Pat. Nos. 6,048,792, 5,787,336, and Re. 36,571. In accordance with the present invention, rectifier 320 is connected to differential oscillator 310 as follows: (1) the gate of rectifying transistor M3 is coupled to the gate of transistor M2 through DC blocking capacitor C3; (2) the gate of rectifying transistor M4 is coupled to the gate of transistor M1 through DC blocking capacitor C4; (3) the drain of rectifying transistor M3 is coupled to the gate of transistor M1; and (4) the drain of transistor M4 is coupled to the gate of transistor M2. In addition, the sources of transistors M3 and M4 are connected together at output node 340, from which capacitor C_{H} is connected to ground.

Rectifier 320 operates in conjunction with differential oscillator 310 in the following fashion. When supply voltage V_{GEN} is initially applied, current begins to flow from voltage supply V_{GEN} through the two branches of differential oscillator 310—one branch formed by inductor L1 and transistor M1 and a second branch formed by inductor L2 and transistor M2. Because inductors L1 and L2 are preferably quite small, the voltages at the drain of transistors M1 and M2 (V_{DS1} and V_{DS2}, respectively) rise rapidly from ground potential toward voltage V_{GEN}. These rapidly-increasing voltages pass through capacitors C1 and C2, thus also increasing the voltages at the gates of transistors M1 and M2 (V_{GS1} and V_{GS2}). Transistors M1 and M2 correspondingly become more conductive (from drain-to-source). Their drain-source voltages (V_{DS1} and V_{DS2}) correspondingly decrease, and, because the gate of each one is connected to the drain of the other via a capacitor (viz., capacitors C1 and C2), gate voltages V_{GS1} and V_{GS2} correspondingly decrease. Thus, for a brief instant of time, the circuit reaches a tenuous initial equilibrium operating point.

But this equilibrium is easily disturbed by, e.g., initial voltages or other electrical noise. The current through one branch inevitably becomes larger than that in the other branch, and the circuit begins to oscillate. For example, assume that the current through inductor L1 and transistor M1 increases relative to that through inductor L2 and transistor M2, thereby decreasing the voltage at the drain of transistor M1 (V_{DS1}). The negative fluctuation in voltage V_{DS1} in turn passes through (and negatively charges) capacitor C2, thereby lowering (and, indeed, forcing negative) the gate-source voltage of transistor M2 (V_{GS2}). As transistor M2 becomes correspondingly less conductive, the voltage at the drain of transistor M2 (V_{DS2}) increases. This positive fluctuation in voltage V_{DS2} likewise passes (and positively charges) capacitor C1 and increases voltage V_{GS1}. In turn, the current through inductor L1 and transistor M1 increases still further. This positive cycle continues until transistor M1 is saturated and transistor M2 is pinched-off.

Meanwhile, the fluctuations in the voltages at the gates of transistors M1 and M2 (V_{GS1} and V_{GS2}) also pass through capacitors C3 and C4 to the gates of rectifying transistors M3 and M4. Thus, the voltage at the gate of transistor M3 (V_{GS3}) becomes negative, pinching-off transistor M3, while the voltage at the gate of transistor M4 (V_{GS4}) becomes positive, saturating transistor M4. Because voltage V_{GS2} is negative, a negative current is caused to flow from ground through the load resistance R_{L} (and also through capacitor CH) and via transistor M4 to the gate of transistor M2. This current positively charges capacitor C2, raising voltage V_{GS2} until transistor M2 is no longer pinched-off.

At this point, the oscillator “flips,” and the sequence described above is reversed. As transistor M2 begins to conduct, and as its drain-source voltage (V_{DS2}) decreases, the decrease in voltage V_{DS2} passes through capacitor C₁, thereby reducing the gate voltage of transistor M1 (V_{GS1}). As before, as transistor M1 becomes correspondingly less conductive, the voltage at the drain of transistor M1 (V_{DS1}) increases. This positive fluctuation in voltage V_{DS1} likewise passes (and further positively charges) capacitor C2 and further increases voltage V_{GS2}. In turn, the current through inductor L2 and transistor M2 increases still further, until transistor M2 is saturated and transistor M1 is pinched-off by a negative gate-source voltage. The voltage at the gate of rectifying transistor M3 (V_{GS3}) becomes positive, causing transistor M3 to conduct, while that at the gate of rectifying transistor M4 (V_{GS4}) becomes negative, pinching it off. Finally, negative current flows through load R_{L} and via transistor M3 to the gate of transistor M1, raising voltage V_{GS1} until the oscillator flips once more, and the cycle repeats.

The frequency of oscillation of differential oscillator 310 is governed by the values of inductors L1 and L2 and capacitors C1 and C2, as well as the parasitic gate-source and drain-source capacitances of transistors M1 and M2. For sufficiently small values, the frequency of oscillation can be extremely high; the oscillator has successfully been tested at about 4 GHz. The present invention is thus well-suited to applications, such as radio-frequency (“RF”) transmission, in which such high frequencies of operation are needed in order to minimize noise within the RF communication bands.

Those of skill in the art will recognize that the voltage generated by converter 300 can be varied by varying the size of inductors L1 and L2, since they serve as “boost” inductors in the present invention. The currents flowing through inductors L1 and L2 lag the pinch-off of transistors M1 and M2—i.e., currents continue to flow through inductors L1 and L2 after their respective transistors cease to conduct. This continued current flow causes voltages V_{DS1} and V_{DS2} to be boosted above V_{GEN} by a factor of two or more. For example, if voltage V_{GEN} is three volts, voltages V_{DS1} and V_{DS2} will swing from zero volts up to about six volts, or even higher.

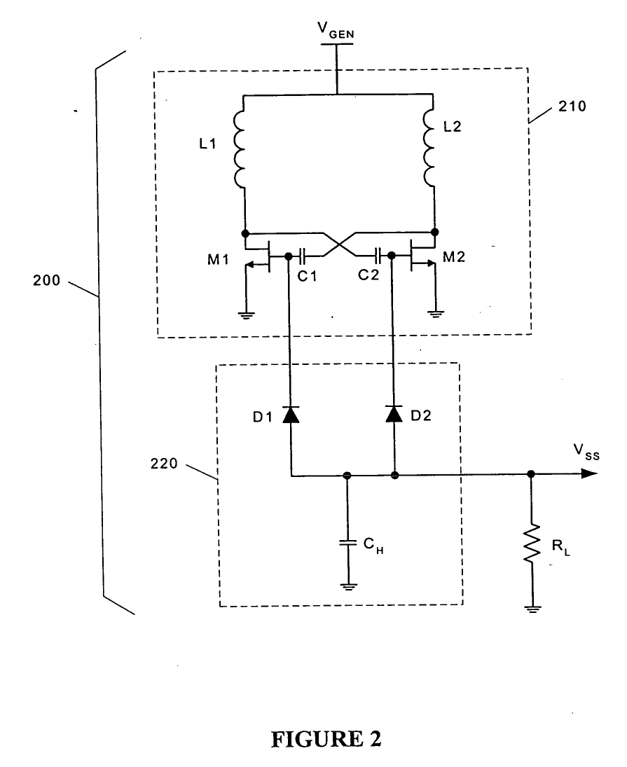

Those of skill in the art will also recognize that the preferred embodiment of converter 300 described above, wherein rectifier 320 is a synchronous rectifier, is significantly more efficient than prior art converters, since the voltage drop across rectifying transistors M3 and M4 is extremely small, especially in comparison with that of the diode-based rectifier of the prior art converter shown in FIG. 2.

In a preferred embodiment, transistors M1 and M2 are MESFETs, which have a parasitic diode from the gate of each transistor to its source. The two parasitic diodes serve two functions. First, they provide over-voltage protection on the gates. Second, they establish an upper limit to voltages V_{GS1} and V_{GS2} of one diode drop (or 0.7 volts, for a GaAs-D-MESFET), which serves as a boundary condition for voltages V_{GS1} and V_{GS2}. For example, if voltages V_{DS1} and V_{DS2} swing from six volts to zero volts (i.e., six volts AC, peak-to-peak), voltages V_{GS1} and V_{GS2} will go from about 0.7 volts down to about −5.3 volts. If such voltages are then rectified by rectifier 320, the output voltage V_{SS} may be as low as, e.g., 4.5 volts.

In another preferred embodiment, a start-up circuit 330 is added to prevent any positive voltage from building up across the load resistance R_{L}. Without this circuit, a large positive voltage can build up and place transistors M1 and M2 into saturation. The inventor has found that, under such a circumstance, oscillator 310 will fail to start oscillating. Start-up circuit 330 may comprise diode D3, as shown in FIG. 3, or any other voltage-limiting component or circuit. Although start-up circuit 330 has here been described in connection with converter 300, it will be recognized that it may also be applied to other converters, such as prior art converter 200.

It will also be recognized that the present invention is not limited to use with MESFETs, but rather may be implemented via other types of transistors, including but not limited to JFETs, MOSFETs, BJTs, HBTs, and PHEMTs.

It is further understood that the embodiments described herein are merely illustrative and are not intended to limit the scope of the invention. One skilled in the art may make various changes, rearrangements and modifications to the illustrative embodiments described above without substantially departing from the principles of the invention, which is limited only in accordance with the claims. Accordingly, all such deviations and departures should be interpreted to be the spirit and scope of the following claims.

1. A DC-to-DC voltage converter operable from a DC voltage supply for providing a DC voltage to a load, the circuit comprising:
a. a differential oscillator, capable of being connected to such DC voltage supply and of producing a differential AC signal;
b. a voltage rectifier having (i) an input port that receives the differential AC signal and (ii) a DC voltage output port; and
c. a start-up circuit, connected to the DC voltage output port and capable of limiting the voltage at the output port to a value sufficient to allow said differential oscillator to begin oscillating.

2. The DC-to-DC voltage converter of claim 1, wherein said start-up circuit comprises a voltage-limiting component.

3. The DC-to-DC voltage converter of claim 1, wherein said voltage-limiting component is a diode.

4. The DC-to-DC voltage converter of claim 1, wherein said voltage rectifier is a diode rectifier.

5. The DC-to-DC voltage converter of claim 1, wherein said voltage rectifier is a synchronous rectifier.

6. The DC-to-DC voltage converter of claim 5, wherein:
a. said differential oscillator includes
i. first and second inductors;
ii. a first oscillating transistor connected to said first inductor for coupling to such DC voltage supply, and
iii. a second oscillating transistor connected to said second inductor for coupling to such DC voltage supply,
iv. wherein said first and second oscillating transistors are cross-coupled to each other such that an electrical oscillation results; and
b. said voltage rectifier includes
i. a first rectifying transistor coupled to said first oscillating transistor, and
ii. a second rectifying transistor coupled to said second oscillating transistor,
iii. wherein said first and second rectifying transistors are cross-coupled to each other such that said voltage rectifier operates synchronously with said differential oscillator.

7. The circuit of claim 6, wherein said first and second inductors are formed from two cross-coupled symmetrical interleaved conductors, such that even-order noise components generated by said differential oscillator substantially cancel at said DC output voltage port.

8. The circuit of claim 6, wherein the output voltage is greater in magnitude than the voltage supplied by such DC voltage supply and negative in polarity.

9. The circuit of claim 6, wherein at least one of said transistors is one of a MESFET, JFET, MOSFET, BJT, HBT, and PHEMT.

10. The circuit of claim 6, wherein said rectifying transistors are MESFETs.

11. A DC-to-DC converter circuit operable from a DC voltage supply for providing a DC voltage to a load, the circuit comprising:
a. a differential oscillator, including
i. first and second inductors,
ii. a first oscillating transistor connected to said first inductor for coupling to such DC voltage supply, and
iii. a second oscillating transistor connected to said second inductor for coupling to such DC voltage supply,
iv. wherein said first and second oscillating transistors are cross-coupled to each other such that an electrical oscillation results; and
b. a voltage rectifier, including
i. a first rectifying transistor coupled to said first oscillating transistor, and
ii. a second rectifying transistor coupled to said second oscillating transistor,
iii. wherein said first and second rectifying transistors are cross-coupled to each other such that said voltage rectifier operates synchronously with said differential oscillator.

12. The circuit of claim 10, wherein said oscillating transistors are MESFETs.

13. A method of converting a first DC voltage to a second DC voltage, comprising the steps of:
a. converting the first DC voltage into an oscillating differential voltage;
b. synchronously rectifying the oscillating differential voltage to produce the second DC voltage; and
c. outputting the second DC voltage at an output port.

14. The method of claim 11, wherein:
a. the oscillating differential voltage is a difference voltage formed by first and second branch oscillating voltages that are 180 degrees out-of-phase with each other, and
b. the step of synchronously rectifying includes the steps of:
i. inputting the first branch oscillating voltage into the current-source terminal of a first transistor having a current-source terminal, a current-sink terminal, and a control terminal;
ii. inputting the second branch oscillating voltage into the current-source terminal of a second transistor having a current-source terminal, a current-sink terminal, and a control terminal;
iii. inputting a control signal to the control terminal of the first transistor, wherein the control signal causes the first transistor to operate synchronously with the first branch oscillating voltage;
iv. inputting a control signal to the control terminal of the second transistor, wherein the control signal causes the second transistor to operate synchronously with the second branch oscillating voltage; and
v. outputting first and second rectified voltages from the control-sink terminal of each of the first and second transistors.

15. A method of starting-up a DC/DC voltage converter comprising (i) a differential oscillator capable of receiving a supply voltage and (ii) a rectifier having an output port, comprising the steps of:
a. voltage-limiting the voltage at the output port, and then
b. connecting the supply voltage to the differential oscillator.
